(19) United States
(12) Patent Application Publication
(10) Pub. No.: US 2019/0281836 A1
(43) Pub. Date: Sep. 19, 2019

(54) SOIL CONDITIONING AGENTS

(71) Applicant: OGET INNIVATIONS GMBH, Allerheiligen bei Wildon (AT)

(72) Inventor: András Horváth, Nagyhalasz (HU)

(21) Appl. No.: 16/348,714

(22) PCT Filed: Nov. 21, 2017
(86) PCT No.: PCT/EP17/79886

§ 371 Date: May 9, 2019

(30) Foreign Application Priority Data
Nov. 21, 2016 (EP) 16199814.1

(51) Int. Cl. A01N 65/08; C09K 17/14; C09K 17/42

(52) U.S. Cl. CPC A01N 65/08; C09K 17/42; C09K 17/14

(57) ABSTRACT

The invention relates to a process for preparing a soil conditioning agent comprising an extract of a plant from the genus Asclepias, wherein the extraction is carried out using a multi-step extraction process and to the soil conditioning agent thereof. The invention further relates to a granulate comprising the soil conditioning agent. The use of the soil conditioning agent and a granulate comprising the soil conditioning agent to control pests on agricultural land is also part of the invention.

### FIELD OF THE INVENTION

The invention concerns a soil conditioning agent comprising an extract of a plant from the genus Asclepias and a process for preparing the same. The invention further relates to granulates comprising the soil conditioning agent of the invention and a process for preparing the same. The use of the soil conditioning agents and granulates are also part of the invention.

### BACKGROUND OF THE INVENTION

Soil-dwelling pests can have a detrimental effect on the health of a plant growing in infested soil. In the last century, the use of synthetic compounds as pesticides, insecticides, fungicides and miticides to treat the plant and the soil have proven to be effective in the control of plant pests. Crops with improved yields have been obtained as a result of the use of chemical pest controlling agents. However, it has been recognised that part of these chemical pest controlling agents are washed into the ground water supply and also accumulate in the plants, from where they are passed on when consumed by animals or humans having potentially serious health consequences. This has led to an increased awareness and a need to control the use of such synthetic compounds to combat pests.

Furthermore, the situation has been worsened by the resistance of the pests to synthetic pesticides, insecticides, fungicides and miticides. The problem of increased resistance and accumulation of the chemical agent in the plant has led to the search for alternative compositions to fight pests. As a consequence of the effects mentioned above, increasing regulations have been imposed and in some cases effective chemical pest controlling agents were banned in many countries.

There is a need to employ more environmentally safe methods for the control of pests as a viable alternative to the use of synthetic chemical pesticides, insecticides, fungicides and miticides.

### SUMMARY OF THE INVENTION

It is the aim of the present invention to provide a soil conditioning agent from a natural extract to provide an environmentally safe way of controlling pests. In addition, the soil conditioning agents are intended to improve the condition of the soil treated.

The present invention is defined in the appended claims.

In accordance with a first aspect, there is provided a process for preparing a soil conditioning agent comprising an extract of a plant from the genus Asclepias, wherein the extraction is carried out using a multi-step extraction process. In certain embodiments the extraction process is simple, effective and cost effective.

In accordance with a second aspect, there is provided a soil conditioning agent obtainable by the process of the first aspect. The soil conditioning agent comprises a natural extract of a plant from the genus Asclepias and as such may provide an environmentally friendly alternative to the use of synthetic chemical pesticides, insecticides, fungicides and miticides.

In accordance with a third aspect, there is provided a granulate comprising the soil conditioning agent of the second aspect. A method of producing a granulate of the third aspect is provided in a fourth aspect. In certain embodiments the granulate is convenient to handle, store and apply. In certain embodiments the matrix material composition and the structure of the granulate itself has an ameliorating effect.

In accordance with a fifth aspect there is provided a method of treating soil by applying a soil conditioning agent of the second aspect or a granulate of the third aspect to the soil. Once applied to the soil, the granulate releases the soil conditioning agents over a prolonged period. It has been found that the granulate remains in the soil for a significant period of time, especially in comparison with other methods of soil treatment. In certain embodiments a single application during a season makes the granulate easy to use as it maintains the desired effect of repelling pests from the treated soil.

The present invention has the advantage that the soil conditioning agents and the granulates claimed may be environmentally friendly and can be effective in improving the condition of the soil in terms of its water and/or air buffering, water drainage, nutrient content, storage and release and/or rendering it free from pests. The present invention also has the advantage that the soil conditioning agents may control pests in the treated area of soil without killing the targeted pests or the useful soil biota.

In certain embodiments plants growing on treated soil have been observed to be in better health than plants growing on untreated soil. In the absence of pests, improved water and/or nutrient utilisation, less plant damage may feature in the improved soil and hence the yields and condition of the plant growing on this soil may be improved. As the present invention achieves improved soil characteristics without the use of synthetic chemical pesticides, insecticides, fungicides and miticides, the introduction of harmful compounds to the soil and ground water, which can enter and remain in the plant may be avoided.

The details, examples and preferences provided in relation to any particular one or more of the stated aspects of the present invention apply equally to all aspects of the present invention. Any combination of the embodiments, examples and preferences described herein in all possible variations thereof is encompassed by the present invention unless otherwise indicated herein, or otherwise clearly contradicted by context.

### BRIEF DESCRIPTION OF THE DRAWINGS

The invention will further be illustrated by reference to the following figures:

FIG. 1: represents an HPLC trace of resin 1 of the inventive example S2;

FIG. 2: represents an HPLC trace of resin 2 of the inventive example S2;

FIG. 3: represents an HPLC trace of comparative example 1;

FIG. 4: represents an HPLC trace of comparative example 4;

FIG. 5: represents an HPLC trace of comparative example 5;

FIG. 6: comparison of plants from untreated soil (a) and plants from soil treat with the inventive example S2 (b).

It is understood that the following description and references to the figures concern exemplary embodiments of the present invention and shall not be limiting the scope of the claims.

### DETAILED DESCRIPTION

In accordance with the first aspect there is provided a process for preparing a soil conditioning agent comprising an extract of a plant from the genus Asclepias, wherein the extraction is carried out using a multi-step extraction process. Soil conditioning agents may improve a number of properties of the soil, such as rendering them free from pests, improving their water utilisation, improving the drainage of the soil and improving the nutrient content of the soil. The soil conditioning agents of the present invention comprise an extract of a plant from the genus Asclepias. Preferably, in comparison to synthetic chemical pesticides, insecticides, fungicides and miticides, the natural extract according to the invention is less harmful or not harmful to human and animal health. Preferably, in comparison to synthetic chemical pesticides, insecticides, fungicides and miticides, the natural extract according to the invention may have less of an influence or does not influence the behaviour of the earthworms. The behaviour of the earthworms may be influenced by synthetic chemical pesticides, insecticides, fungicides and miticides in that the earthworms may have stunted growth and/or produce suboptimal larvae. Without being bound by theory, the lesser influence of the soil conditioning agent of the present invention on the earthworm may be due to a certain resistance provided by a secretion produced on the outside of the earthworm. Earthworms are known to be important to the condition of the soil as their activity aerates and mixes the soil. The nutrient content of the soil may also be aided by earthworms as they create nutrient rich castings that is important for plant growth.

Plants of the genus Asclepias, commonly known as milkweeds are herbaceous perennial, dicotyledonous plants. In the present invention, the extract of the dried superterranean parts of the plant are used as a soil conditioning agent. As used herein, the term “superterranean” refers to the part of the plant that is above ground such as the stem, flower and/or leaf. The root of the plant is not used in the extraction process of the present invention.

Plant species of the genus Asclepias according to the present invention include, but are not limited to: Asclepias albicans, Asclepias amplexicaulis, Asclepias asperula, Asclepias californica, Asclepias cordifolia, Asclepias cryptoceras, Asclepias curassavica, Asclepias curtissii, Asclepias eriocarpa, Asclepias erosa, Asclepias exaltata, Asclepias fascicularis, Asclepias humistrata, Asclepias incarnata, Asclepias lanceolata, Asclepias linaria, Asclepias linearis, Asclepias longifolia, Asclepias rneadii, Asclepias nyctaginifolia, Asclepias obovata, Asclepias purpurascens, Asclepias quadrifolia, Asclepias rubra, Asclepias solanoana, Asclepias speciosa, Asclepias subulata, Asclepias subverticillata, Asclepias sullivantii, Asclepias syriaca, Asclepias tuberosa, Asclepias uncialis, Asclepias variegata, Asclepias verticillata, Asclepias vestita, Asclepias viridiflora, Asclepias viridis and Asclepias welshii. Due to phytochemical aspects, the preferred species is selected from Asclepias albicans, Asclepias asperula, Asclepias incarnata, Asclepias speciosa, Asclepias subulata, Asclepias syriaca and Asclepias tuberosa. A preferred species is Asclepias syriaca.

An extract in the meaning of the invention must be obtained by a solid-liquid extraction.

In an embodiment of the invention a soil condition agent is prepared comprising an extract, wherein the extraction is carried out in a multi-step extraction process. The extraction process of the present invention may yield specific compounds and/or yield a larger range of compounds, which are not obtained using known extraction processes. In certain embodiments, the extraction process of the present invention leads to compounds with high molecular weights being extracted. In certain embodiments, the yield of the extract obtained by the present process may be higher than obtained by known processes, particularly in comparison to water-based extraction processes. Preferably, the extraction process comprises the steps of:
a) providing chopped and dried superterranean parts of the plant;
b) mixing the chopped and dried superterranean parts of the plant with one or more solvent(s);
c) filtering the solvent-wet biomass of step b;
d) mixing the remaining solvent-wet biomass of step c with one or more solvent(s); and
e) filtering the solvent-wet biomass of step d.

The solvents used in step b) may be selected from water, alcohols such as propanols, butanols, pentanols or hexanols. The extraction is not carried out with ethanol. The solvents used in step d) may be selected from ketone solvents such as acetone, butanones, cyclopentanones, ethyl isopropyl ketone, 2-hexanone, methyl isobutyl ketone, methyl isopropyl ketone, 3-methyl-2-pentanone, 2-pentanone, 3-pentanone and mixtures thereof.

The filtration of step c) and e) may be carried out though a 120 μm filter.

In one embodiment the filtrates of steps b) and d) of the above process are concentrated. The concentrated extract may then be diluted in a solvent such as glycerol to provide a glycerol dilution. The said solution comprises from about 0.1% to 2% by weight, from about 0.5% to 3% by weight, from about 1% to 2% by weight, from about 1% to 4% by weight, from about 2% to 5% by weight, from about 3% to 7% by weight, from about 4% to 9% by weight, from about 5% to 10% by weight, from about 7% to 15% by weight, from about 10% to 20% by weight of the concentrated extract based on the total weight of the glycerol dilution.

Preferably, the process for preparing a soil conditioning agent according to the invention provides an extract comprising one or more terpenes, such as phytol. Phytol may be present in an amount of from about 0.02% to 0.1%, from about 0.5% to 1% by weight, from about 0.5% to 2% by weight, from about 0.6% to 1.8% by weight, from about 0.7% to 1.6% by weight, from about 0.8% to 1.4% by weight, from about 0.9% to 1.3% by weight, from about 1.0% to 1.2% by weight, from about 1.1% to 1.2% by weight of the concentrated extract. Without wishing to be bound by theory, it is thought that terpene such as phytol act as an irritants, repelling any pests that it contacts.

Preferably, the process for preparing a soil conditioning agent according to the invention provides an extract comprising terpene in an amount less than 50% by weight, more preferably in an amount less than 45% by weight, more preferably in an amount less than 40% by weight, more preferably in an amount less than 30% by weight, more preferably in an amount less than 20% by weight, more preferably in an amount less than 15% by weight of the concentrated extract.

The extract from the plant of the genus Asclepias may also comprise steroidal compounds, oxygen containing aliphatic/alicyclic hydrocarbons, aliphatic carboxylic acids, oxygen containing monoaromatic hydrocarbons, aliphatic amides, palmitic acid, oleic acid, linoleic acid, lignoceric acid, stearic acid, tricosanoic acid, vanillic acid, galic acid, syringic acid and/or p-coumaric acid. Without wishing to be bound by theory, it is thought that the listed compounds bind to the colloidal phases of the soil in the rhizosphere, thereby creating a soil environment favourable for plant growth.

Preferably, the soil conditioning agents according to the invention do not contain mineral salt additives from an external source. The following inorganic components may be present in the soil conditioning agents of the present invention and are yielded from the plant material during the extraction process: phosphorus, potassium, calcium, magnesium, sulfur, nitrogen, boron, iron, manganese, molybdenum, zinc, arsenic, cadmium, cobalt, chrome, copper, mercury, nickel, lead and/or selenium.

In a particularly preferred embodiment a plant of the genus Asclepias is extracted using water and isopropanol (step b) and butanone (step d). In a preferred embodiment the concentrate of an extract of Asclepias using water and isopropanol (step b) and butanone (step b), is diluted with glycerol. Preferably, the solution with glycerol comprises from about 1.1% to 1.2% by weight, from about 1.0% to 2.0% by weight or from about 1.5% to 3.0% by weight of the concentrated extract.

In accordance with a second aspect, there is provided a soil conditioning agent obtainable by the process of the first aspect.

In accordance with a third aspect, there is provided a granulate comprising the soil conditioning agent of the second aspect. The granulate comprises a porous vitreous, ceramic material or quartz sand.

Porous materials according to the invention include naturally occurring, partly devitrificated pumice tuffs as well as industrially produced expanded clay-ceramic pebbles. Advantageously, such porous materials have the capability of taking up soil conditioning agents and releasing them at a slow rate. Preferably, the porous tuffaceous material comprises zeolite minerals, more preferably the porous tuffaceous material obtained by the process of devitrification is completely zeolitized. Preferably, the porous pumice tuff is a product of devitrification and comprises the zeolite mineral clinoptilolite, more preferably the porous material is clinoptilolite. Zeolites are microporous aluminosilicate minerals with interconnected microporous spaces in the crystal structure, which allow for large amounts of soil conditioning agent to be stored and subsequently to be released slowly.

Naturally occurring zeolites are formed when volcanic rocks and ash layers react with alkaline water. Moreover, zeolites can also be produced by artificial synthesis. Zeolites are microporous structures that can accommodate a wide variety of cations and also have a high water storage capacity. Zeolites have an ordered crystal structure with a very large amount of cavities and a large active surface area (typically 400-600 m²/g). In addition to the zeolites, alternative minerals with a porous or layer structure, which can be used as the granulates according to the invention include sepiolite, palygorskite, kaolinate, halloysite, metahalloysite, illite, vermiculite, montmorillonite, beidellite, nontronite, saponite, glauconite, chlorite, attapulgite, gibbsite, hematite, goethite, limonite and pyrolusite, or mixtures thereof.

The granulate according to the invention can be made by applying the soil conditioning agent onto the granules by spraying, wetting dipping, misting, drenching, showering, fogging, soaking, dampening, drizzling, dousing and splashing. Preferably, the soil conditioning agent is sprayed onto the granulate. Preferably the treated granulate is made up of about 99% by weight zeolite and about 1% by weight of soil conditioning agent in glycerol, or about 95% by weight zeolite and about 5% by weight of soil conditioning agent in glycerol, or about 90% by weight zeolite and about 10% by weight of soil conditioning agent in glycerol, or about 85% by weight zeolite and about 15% by weight of soil conditioning agent in glycerol, or about 80% by weight zeolite and about 20% by weight of soil conditioning agent in glycerol. In certain embodiments the soil conditioning agent is present in about 0.1% to about 20% in the glycerol dilution. In one embodiment the treated granulate is made up of about 80% by weight of zeolite and about 20% by weight of soil conditioning agent in glycerol, wherein the glycerol dilution comprises 10% by weight of the soil conditioning agent.

The granulate comprising the soil conditioning agent is convenient to handle and store, with a shelf life of at least 1 year, at least 1.5 years, at least 2 years, at least 2.5 years or at least 3 years.

In a further embodiment of the invention the soil conditioning agent and/or a granulate comprising a soil conditioning agent are used for treating soil. The soil conditioning agents repel a host of pests. Preferably, the pest is Nematoda, Nemathelminthes, Aschelminthes, Ditylenchus dipsaci, Globodera rostochiensis, Insecta, Elateridae, Coleopthera, Melolonthidae, Melolontha melolontha, Curculionidae, Tanimecus dilaticollis, Cleonus punctiventris, Chrysomelidae, Arthropoda, Belonolaimus, Criconemoide, Helicotylenchu, Heterodera zeae, Hoplolaimus, Xiphinema, Longidorus, Meloidogyne, Pratylenchus, Paratrichodorus, Tylenchorhynchus, Globodera pallida, Ditylenchus destructor, Chaetognatha, Gnathostomulid, Hemichordata, Nematomorpha, Nemertea, Onychophora, Phoronida, Platyhelminthes, Priapulida, Sipuncula, Phytophythora, Fusarium, Pythium, Rhizoctonia, Sclerotinia, Erwinia, Verticillium, Agriotes such as Agriotes lineatus, Agriotes mancus, Agriotes obscurus, Agriotes sputator, Diabrotica, Diabrotica virgifera, Diabrotica virgifera virgifera, Cydia pomonella, Eupoecilia ambiguella, Lobesia botrana, Leptinotarsa decemlineata, Psylliodes, Chetocnema tibialis and Leptinotarsa decemlineata, and where applicable, the larvae thereof. In a further embodiment, the soil conditioning agents do not significantly influence the behaviour of earthworms, such as Lumbricus terrestris.

Without being bound by theory, it is thought that the soil conditioning agents of the invention do not act as pesticides, insecticides, fungicides and miticides by killing the target pest. Rather, the soil conditioning agent is thought to act to repel the pest with the use of skin irritating agents such as terpenes. The pest free area is therefore predominantly due to the pests being displaced from the treated area, either to the soil surface or to other areas of soil.

Plants may be planted in the soil before, during or after it is treated with the soil conditioning agent. Preferably the plant is selected from the list of cereals, such as wheat, barley, oats, rye and triticale, sugar beet, fodder beet, beetroot, sunflower, pumpkin, broad bean, millet, rapeseed, green pea, soybean, peas, leguminose, maize, oilseed rape, parsley, celery, mustard, grapevine, stone fruit, such as peaches, plums and cherries, apple, pear, berries, pepper, tomato, cabbage, potato, sweet potato, garlic, carrot, sweet pepper, cucumber, lettuce, root vegetables, radish, horseradish, red radish and white radish.

After application on the soil, the soil conditioning agent may be active for at least at least 65 days, or at least 40 days, or at least 35 days or at least 30 days. The granulate comprising the soil conditioning agent is active for at least 70 days, at least 65 days, at least 60 days, at least 55 day or at least 50 days after application. The activity as stated above applies to normal weather conditions for the region and time of year, whereas some variation may occur with, for example, unexpectedly high rainfall or unexpectedly high temperatures.

Plants that grow on soil treated with the soil conditioning agent and/or granulate according to the invention may be in better health than plants planted in untreated soil. The plants growing in the treated soil may have leaves with thick plant cuticles, which may be due to the manifestation of diseases in such plants being lower than in untreated plants. The plants growing in treated soil may also be taller, have a greater green mass weight and/or a higher dry biomass than untreated soil and/or soil treated with known extracts.

The formulations according to this invention can be applied to the area of soil to a depth of 5 to 8 cm in an amount of about 10 to 20 kg/ha, preferably, about 15 kg/ha.

For the avoidance of doubt, the present application is directed to the subject-matter described in the following numbered paragraphs:
1. A process for preparing a soil conditioning agent comprising an extract of a plant from the genus Asclepias, wherein the extraction is carried out using a multi-step extraction process.
2. The process of paragraph 1, wherein only the chopped and dried superterranean parts of the plant are used.
3. The process of paragraph 1 or paragraph 2, wherein the extraction process comprises the steps of:
   a) providing chopped and dried superterranean parts of the plant;
   b) mixing the chopped and dried superterranean parts of the plant with one or more solvent(s);
   c) filtering the solvent-wet biomass of step b;
   d) mixing the remaining solvent-wet biomass of step c with one or more solvent(s); and
   e) filtering the solvent-wet biomass of step d.
4. The process of paragraph 3, wherein in step b) the solvents used are water and/or alcohol.
5. The process of paragraph 4, wherein in step b) the solvents used are water and/or isopropanol.
6. The process of any one of paragraphs 3 to 5, wherein in step d) the solvent used is a ketone type solvent.
7. The process of paragraph 6, wherein in step d) the solvent used is butanone.
8. The process of any one of paragraphs 3 to 7, wherein the filtrates obtained from steps b) and d) are concentrated.
9. The process of paragraph 8, wherein the concentrate is diluted with glycerol.
10. The process of any one of the preceding paragraphs, wherein the plant is selected from Asclepias albicans, Asclepias asperula, Asclepias incarnata, Asclepias speciosa, Asclepias subulata, Asclepias syriaca and Asclepias tuberosa.
11. The process of any one of the preceding paragraphs, wherein the plant is selected from Asclepias syriaca.
12. The process of any one of the preceding paragraphs, wherein the soil conditioning agent comprises phytol.
13. The process of any one of the preceding paragraphs, wherein the soil conditioning agent comprises less than 50% terpene.
14. A soil conditioning agent obtainable by the process of any one of the preceding paragraphs.
15. A granulate comprising the soil conditioning agent of paragraphs 14.
16. The granulate of paragraph 15, wherein the granulate comprises quartz sand or zeolite.
17. The granulate of paragraph 15 or 16, wherein the soil conditioning agent is adapted to be released slowly.
18. The granulate of paragraph 17, wherein the soil conditioning agent is adapted to be released in more than 30 days.
19. A method of producing the granulate of paragraphs 15 to 18.
20. The method of paragraph 19, wherein the soil conditioning agent according to paragraph 14 is sprayed onto the granulate.
21. A method of paragraphs 19 or 20, wherein the soil conditioning agent is diluted in glycerol.
22. A method of paragraph 21, wherein the soil conditioning agent is present in an amount of about 0.1 to 20% by weight in the glycerol dilution based on the total weight of the glycerol dilution.
23. A method of treating soil by applying a soil conditioning agent according to paragraph 14 or a granulate according to any one of paragraphs 15 to 18 to the soil.
24. Use of a soil conditioning agent according to paragraph 14 or a granulate according to any one of paragraphs 15 to 18 for treating soil.
25. Use of a soil conditioning agent according to paragraph 14 or a granulate according to any one of paragraphs 15 to 18 to displace pests from the soil.
26. The use according to paragraph 25, wherein earthworms are not displaced.

### EXAMPLES AND EXPERIMENTAL DATA

### Inventive Example 1

100 g of chopped and dried Asclepias syriaca (stalk and leaves) is mixed at room temperature for 1 hour with a solvent containing 300 ml of 2-propanol and 300 ml of water, then filtered through a 120 μm filter. The solvent from the colloidal filtrate is evaporated under vacuum to yield 19 g of black viscous residue (residue 1).

To the wet biomass left on the filter is added 500 ml of butanone, which is then filtered through a 120 μm filter. The solvent from the filtrate is evaporated under vacuum to yield 7 g of residue (residue 2).

Residue 1 and 2 are combined and 974 ml of glycerol is added and the mixture is homogenized by stirring, providing a solution according to the invention. This solution may also be used to provide a granulate according to the invention.

The homogenised mixture of residue 1 and 2 in glycerol is diluted in water as required and sprayed on to zeolite grits with a grain size of 0.4 to 10 mm. The zeolite grits are then air-dried.

The extract according to inventive example 1 as a solution in glycerol (S) and as a granulate (G) were compared with untreated areas as well as areas treated with known insecticides Force 1.5 G (F), which is in granulate form, and Teflustar (T), which is in liquid form. A number of parameters were compared such as the phytoxicity, vigour of the plant, root damage, lodging, fresh weight of the plant, moisture content of the soil and yield. Results from investigations carried out can be found in Tables 1 and 2.

TABLE 1
Treatment of an area infested with
Elateridae and planted with maize.

| | | Application | | |
|---|---|---|---|---|
| | | rate | Vigour | Infest |
| | | (kg/ha) | (%)¹ | (%)¹ |
| Comparative example | Untreated area | N/A | 33 | 85 |
| Comparative example | F | 15 | 43 | 75 |
| Inventive Example 1 | G | 10 | 68 | 62 |
| Inventive Example 1 | G | 20 | 75 | 55 |

¹Determined 11 days after planting

TABLE 2
Treatment of an area infested with Diabrotica virgifera
applied before sowing maize.

| | | | | Phyto- | Vig- | In- |
|---|---|---|---|---|---|---|
| | | Application | | toxicity | our | fest |
| | | rate | | (%)¹ | (%)¹ | (%)¹ |
| Comparative example | Untreated | N/A | | 0 | 78 | 16 |
| | area | | | | | |
| Comparative example | T | 20 | kg/ha | 1 | 88 | 20 |
| Comparative example | T | 40 | kg/ha | 18 | 68 | 20 |
| Comparative example | T | 50 | kg/ha | 21 | 60 | 23 |
| Inventive Example 1 | S | 4 | l/ha | 0 | 95 | 13 |

¹Determined after 21 days

The results in Table 1 show that areas treated with granulates according to the invention exhibit high vigour of plants and have a reduced rate of infestation in comparison to untreated areas and areas treated with a known insecticide. Similarly, the results in Table 2 show that areas treated with a solution according to the invention exhibit high vigour of the plants, low phytotoxicity and low rate of infestation in comparison to untreated areas and areas treated with a known insecticide.

Further experiments have shown that soil treated with granulates according to the invention do not considerably influence the behaviour of the earthworms in comparison to untreated soil.

### Inventive Example 2

100 g of chopped and dried Asclepias syriaca. was mixed at room temperature for 1 hour with 600 ml of 2-propanol (50%), then filtered through a 120 μm filter. The solvent from the filtrate was evaporated under vacuum to yield 19 g of dense, viscous, dark liquid (residue 1). The HPLC trace obtained from residue 1 is shown in FIG. 1.

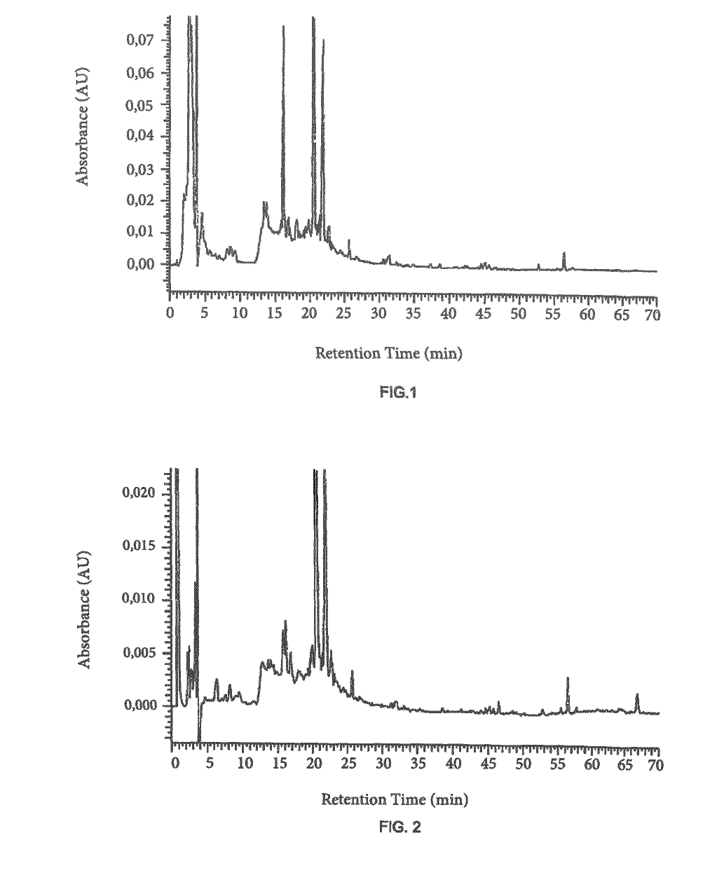

To the wet biomass left on the filter was added 500 ml of butanone, which is then filtered through a 120 μm filter. The solvent from the filtrate is evaporated under vacuum to yield 7 g of residue (residue 2). The HPLC trace obtained from residue 2 is shown in FIG. 2.

Residue 1 and 2 are combined and 974 ml of glycerol is added and the mixture is homogenised by stirring. The resulting liquid (S2) was used in the following experiments and compared with known extracts.

### Comparative Example 1

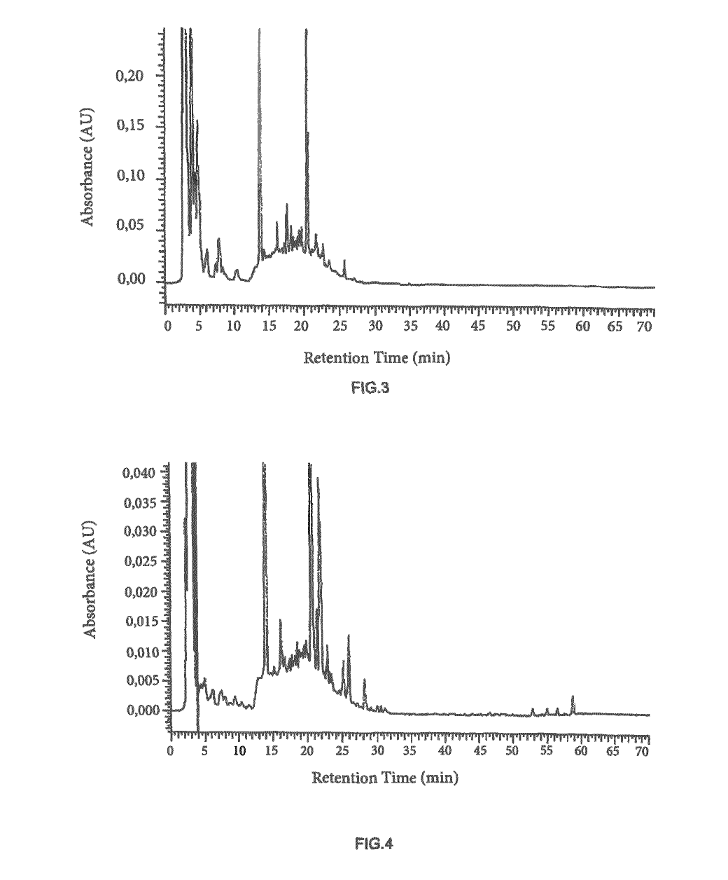

The collected fresh green whole plant material (Asclepias syriaca) was ground and pressed to obtain the plant liquid as comparative example 1. The HPLC trace obtained from comparative example 1 is shown in FIG. 3.

### Comparative Example 2

Asclepias syriaca was dried and extracted by a two steps process in an Erlenmeyer flask on rotating shaker table.

The first extraction step used 500 ml of cyclohexane with an extraction time of 4 hours. After shaking, the solvent, comprising the extracted materials was decanted, the wet plant material washed out with cyclohexanol (2×100 ml) and the solvent residue of the washed plant material was removed by with vacuum suction. Washing liquid was added to the decanted extract. The cyclohexanol extract was then evaporated down and the residue dissolved in 300 ml glycerol. Plant material residue was then extracted by cyclohexanol and then dried at 100° C. for 4 hours.

The second extraction step used 500 ml of methanol with an extraction time of 4 hours. The second extraction step was carried out using the same procedure as first extraction step

The extracts of both extraction steps in glycerol were then combined and made up to 1000 ml by adding glycerol to provide comparative example 2 (CE2).

### Comparative Example 3

Dried Asclepias syriaca was extracted using 800 ml of ethanol (50%) and refluxing for 90 minutes. The ethanol was decanted and a futher 800 ml of ethanol (50%) was added to the wet biomass and refluxed for 90 minutes. The ethanol from this step was combined with the ethanol from the first step and the solvent was evaporated under vacuum. 975 ml of glycerol was then added to the dried residue to yield comparative example 3 (CE3).

### Comparative Example 4

25 g of Asclepias syriaca was ground and mixed with 100 ml distilled water left for 24 hours and then decanted. With this operation several batches of extract were made, combined and filtered to yield comparative example 4 (CE4). The HPLC trace obtained from comparative example 4 is shown in FIG. 4.

### Comparative Example 5

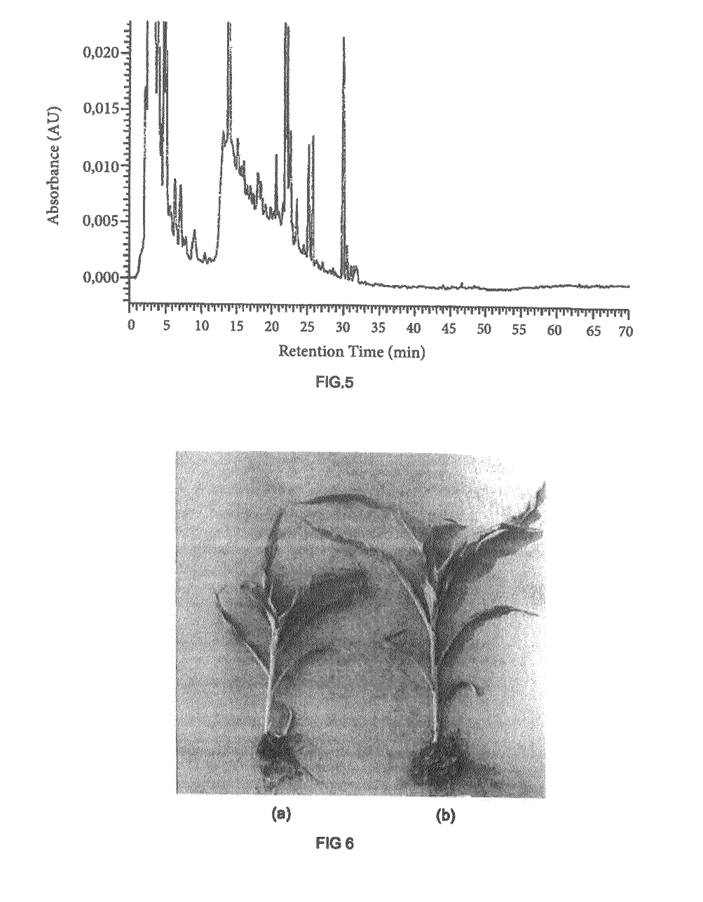

10 g of dried Asclepias syriaca was mixed with 100 ml distilled water and left for 24 hours and then decanted. With this operation several dosages of aqueous mixtures were made, combined and filtered to yield compararative example 5 (CE5). The HPLC trace obtained from comparative example 1 is shown in FIG. 5.

### HPLC Analysis:

Chromatograph: Merck LaChrom Hitachi HPLC
Column: Atlantis dC18 250×4.6 mm (5 μm)
Mobile phase: A=5% water, 95% acetonitrile
   B=acetonitrile
Gradient: 0 minutes: 0% B
   5 minutes: 0% B
   55 minutes: 100% B
   75 minutes: 100% B
   75.1 minutes: 0% B
   95 minutes: 0% B
Flow rate: 1.0 ml/min
Detector: Merck LaChrom Hitachi 7450 DAD
Wavelength: 265 nm
Injection volume: 20 ml

### Sample Preparation:

A sample of CE1 was passed through an aluminium oxide column, then 1 ml of the extract was evaporated to dryness under nitrogen. 200 μl of mobile phase A and 800 μl acetonitrile was then added to the sample.

1 ml of acetonitrile was added to S2 residue 2, 1 ml of mobile phase A to samples S2 residue 1, CE1 and CE5, and 1 ml of 1:1 acetonitrile-water mixture was added to CE4. The redissolved samples were filtered using a regenerated cellulose filter with a pore diameter of 0.45 μm and then injected into the chromatograph.

The HPLC traces are shown in FIGS. 1 to 5. The HPLC traces for the inventive example S2, resin 1 and resin 2, FIGS. 1 and 2, respectively, are seen to differ significantly from the HPLC traces of the comparative examples shown in FIGS. 3, 4 and 5. As seen in FIGS. 1 and 2, the inventive example S2 show one or more of the following retention times: 2.85, 3.07, 3.92, 16.21, 20.57, 20.67, 21.92, 22, 23.25, 25.79, 52.77, 52.85, 56.56, 57.76 mins and 66.93.

The liquid obtained according to Inventive Example 2 (S2) and the liquids according to the prior art (Comparative Examples 1 to 5; CE1 to 5) were tested in controlled experiments as detailed in the following.

Plants were grown for 40 days in plastic pots containing 6 kg of soil according to the following specification.

To aerate the soil, the bottom of the plastic pots were perforated and a layer of washed gravel was placed at the bottom of the soil. Seven seeds were sown in each pot and covered with a layer of soil with a thickness of 3 cm. After weeding, the number of plants was set to four plant per pot. Water supply was provided by daily irrigation and once a week the plants were watered to up to 70% of the water capacity of the soil, which was controlled by weighing. Each of the formulations S2, CE1, CE2, CE3, CE4 and CE5 (1 ml in 100 ml of water) were used to treat the plants in four plant pots. A control with untreated soil was also carried out. The aqueous solution of 1 w/w % of each of S2, CE1, CE2, CE3, CE4 and CE5 in 100 ml of water were sprayed onto the soil surface of the culture vessels at 2.1 ml/pot doses.
Test plant : Sweet corn: Zea mays var. Saccharata (SPIRIT F1)
Soil: meadow chernozem from cultivated land with a pH_{KCl} of 6.9. The soil was air-dried and then screened in a 3 mm knot size sieve, used to fill the pots followed by watering to up to 70% of its water capacity. The soil surface in the pots was 0.035 m²
After 40 days after planting the seed, the plant height (cm), the whole greenmass (g) of the plants and the above ground dry biomass (g) were determined.
The height of plants grown in treated soil and untreated control was measured. The average height of the plants obtained are shown in Table 3.

TABLE 3
Plant height after 40 days

| Treatment of soil | Average height of plants (cm)¹ |
|---|---|
| Untreated control | 34.1 |
| S2 | 45.1 |
| CE1 | 39.7 |
| CE2 | 37.6 |
| CE3 | 39.0 |
| CE4 | 44.3 |
| CE5 | 44.1 |

¹Average calculated 16 plants (from 4 pots, each containing 4 plants)

The whole green mass was determined by cutting the entire superterranean part of the plant and weighing. The average whole green mass obtained can be seen in Table 4.

TABLE 4
Whole green mass (g) after 40 days

| Treatment of soil | Average whole green mass (g)¹ |
|---|---|
| Untreated control | 89.2 |
| S2 | 105.6 |
| CE1 | 92.6 |
| CE2 | 92.0 |
| CE3 | 93.7 |
| CE4 | 101.8 |
| CE5 | 102.3 |

¹Average calculated 16 plants (from 4 pots, each containing 4 plants)

The dry biomass was determined by drying the plants used for determining the whole green mass in an oven at 50° C. for 8 hours. The average dry biomass obtained can be seen in Table 5.

TABLE 5
Dry biomass (g) after 40 days

| Treatment of soil | Average dry biomass (g)¹ |
|---|---|
| Untreated control | 18.13 |
| S2 | 26.64 |
| CE1 | 21.14 |
| CE2 | 21.85 |
| CE3 | 20.77 |
| CE4 | 25.01 |
| CE5 | 25.41 |

¹Average calculated 16 plants (from 4 pots, each containing 4 plants)

As may be seen from the Tables 3, 4 and 5, the plants grown in the soil treated with S2 outperformed those grown in untreated soil or soil treated with any one of CE1 to CE5. The plants grown in soil treated with S2 were found on average to be taller with a greater green mass and dried biomass than the comparative examples. Furthermore, the roots of the plants grown in soil treated with S2 were much richer than the roots of the plants grown in untreated soil as seen in FIG. 6.

1. A process for preparing a soil conditioning agent comprising an extract of a plant from the genus Asclepias, wherein the extraction process comprises the steps of:
a) providing chopped and dried superterranean parts of the plant;
b) mixing the chopped and dried superterranean parts of the plant with one or more solvent(s);
c) filtering the solvent-wet biomass of step b;
d) mixing the remaining solvent-wet biomass of step c with one or more solvent(s); and
e) filtering the solvent-wet biomass of step d.

2. The process of claim 1, wherein in step b) the solvents used are water or alcohol, or both.

3. The process of claim 1, wherein in step d) the solvent used is a ketone type solvent.

4. The process of claim 1, wherein the filtrates obtained from steps b) and d) are concentrated and the concentrate is optionally diluted with glycerol.

5. The process of claim 1, wherein the plant is selected from Asclepias albicans, Asclepias asperula, Asclepias incarnata, Asclepias speciosa, Asclepias subulata, Asclepias syriaca and Asclepias tuberosa.

6. The process of claim 1, wherein the soil conditioning agent comprises phytol and/or less than 50% terpene.

7. A soil conditioning agent obtainable by the process of claim 1.

8. A granulate comprising the soil conditioning agent of claim 7.

9. The granulate of claim 8, wherein the granulate comprises quartz sand or zeolite.

10. The granulate of claim 8, wherein the soil conditioning agent is adapted to be released slowly, preferably the soil conditioning agent is adapted to be released in more than 30 days.

11. A method of producing the granulate of claim 8.

12. A method of treating soil, the method comprising applying the soil conditioning agent of claim 7, or a granulate thereof, to the soil.

13. (canceled)

14. A method to displace pests from soil, the method comprising applying the soil conditioning agent of claim 7, or a granulate thereof, to the soil.

15. The process of claim 2, wherein the alcohol is isopropanol.

16. The process of claim 2, wherein in step d) the solvent used is a ketone type solvent.

17. The process of claim 3, wherein the ketone type solvent is butanone.

18. The process of claim 16, wherein the ketone type solvent is butanone.

19. The process of claim 4, wherein the concentrate is diluted with glycerol.

20. The granulate of claim 9, wherein the soil conditioning agent is adapted to be released slowly, preferably in more than 30 days.
